(19) United States
(12) Patent Application Publication
(10) Pub. No.: US 2014/0337253 A1
(43) Pub. Date: Nov. 13, 2014

(54) TRANSMITTING CHARGE EVENT INFORMATION TO ELECTRICAL UTILITY THROUGH TELEMATICS COMMUNICATION INFRASTRUCTURE

(71) Applicant: GM Global Technology Operations LLC, Detroit, MI (US)

(72) Inventors: Vyacheslav Berezin, Newmarket (CA); Norman J. Weigert, Whitby (CA)

(21) Appl. No.: 13/889,911

(22) Filed: May 8, 2013

(51) Int. Cl. G06Q 50/06

(52) U.S. Cl. CPC G06Q 50/06
USPC 705/412

(57) ABSTRACT

Implementations of the present invention contemplate using the communicative connections between a telematics unit in a vehicle and a telematics service provider (TSP) to transmit information pertaining to a vehicle charging event from the vehicle to the TSP and ultimately to electrical power utility companies that provide the electrical power used to charge the vehicle. Specifically, implementations of the present invention contemplate provisioning electrical vehicle supply equipment (EVSE) by linking the EVSE to a particular energy user metering device (EUMD). Implementations of the invention further contemplate a telematics unit in an electric vehicle that acquires a unique identifier of the EVSE when the vehicle uses the EVSE to recharge its battery and that transmits the unique identifier to a TSP for subsequent transmission to the electrical power utility.

### TECHNOLOGY FIELD

The present disclosure relates generally to vehicular telematics systems and more specifically to the use of telematics units within electric vehicles to establish communicative connections with electrical power utilities that supply the electricity used to charge the electric vehicles.

### BACKGROUND

Consumer demand for electric vehicles has increased in recent years and may continue to increase in the future. Growing consumer demand for electric vehicles has been propelled by increasing fossil fuel prices and the resulting increase in the operational costs of internal combustion vehicles. Simultaneously, consumer demand for electric vehicles has been further propelled by concerns that the combustion of fossil fuels causes environmental degradation. Environmental concerns have engendered legislation designed to reduce the costs of “clean” technologies relative to alternative technologies that are associated with pollution. For example, tax incentives and government rebates have been provided to purchasers of electric vehicles. Nevertheless, the limited range of electric vehicles can be an inconvenience to many drivers and limit the viability of electric vehicles for consumers who desire the ability to travel long distances without significant delays caused by recharging and by locating and traveling to recharging stations.

The construction of an infrastructure of electric vehicle charging stations is necessary to increase the effective range and utility of electric vehicles. Increasing the range and utility of electric vehicles by expanding the infrastructure of charging stations will increase consumer demand for electric vehicles. Furthermore, the expansion of the electric vehicle charging infrastructure will create opportunities for utility companies that supply electricity to increase their electricity sales. As larger numbers of consumer's transition from driving internal combustion vehicles to driving electric vehicles, sales of electricity used to power electric vehicles will experience a corresponding increase.

### SUMMARY OF THE INVENTION

Implementations of the present invention contemplate using the communicative connections between a telematics unit in a vehicle and a telematics service provider (TSP) to transmit information pertaining to a vehicle charging event from the vehicle to the TSP and ultimately to electrical power utility companies that provide the electrical power used to charge the vehicle. Specifically, implementations of the present invention contemplate provisioning electrical vehicle supply equipment (EVSE) by linking the EVSE to a particular energy user metering device (EUMD). In some implementations, the linking is accomplished by transmitting a unique identifier for the EVSE and a unique identifier for the EUMD along with instructions for associating the two unique identifiers with one another to an electrical power utility upon installation of the EVSE. Implementations of the invention further contemplate a telematics unit in an electric vehicle that acquires the unique identifier of the EVSE when the vehicle uses the EVSE to recharge its battery and that transmits the unique identifier to a TSP for subsequent transmission to the electrical power utility. Implementations of the present invention thereby provide a means for providing, to a utility company, the identity of a vehicle that receives a quantity of electricity measured by a particular EUMD during a charging event as well as additional information associated with the electric vehicle.

One implementation consists of a method for transmitting information pertaining to a charging event of a plug-in electric vehicle (PEV) to an electrical utility, wherein the electrical utility is the provider of the electrical power acquired by the PEV during the charging event, the method comprising receiving, at a telematics unit of the PEV, information pertaining to the charging event, transmitting, by the telematics unit, the information pertaining to the charging event or a subset thereof to a telematics service provider (TSP), and transmitting, by the telematics unit, instructions directing the TSP to transmit the information pertaining to the charging event or a subset thereof to the electrical utility, wherein the information pertaining to the charging event comprises a unique identifier of an electric vehicle supply equipment (EVSE).

An additional implementation consists of a method for transmitting information pertaining to a charging event of a plug-in electric vehicle (PEV) to an electrical utility, wherein the electrical utility is the provider of the electrical power acquired by the PEV during the charging event, the method comprising receiving, at a telematics service provider (TSP), information pertaining to the charging event, and transmitting, by the TSP, the information pertaining to the charging event or a subset thereof to the electrical utility, wherein the information pertaining to the charging event comprises a unique identifier of an electric vehicle supply equipment (EVSE).

A further implementation consists of a system for transmitting information pertaining to a charging event of a plug-in electric vehicle (PEV) to an electrical utility, wherein the electrical utility is the provider of the electrical power acquired by the PEV during the charging event, the system comprising an electric vehicle supply equipment (EVSE) configured to supply electrical power to the PEV and to transmit its unique identifier to a telematics unit of the PEV, the telematics unit of the PEV configured to receive the unique identifier of the EVSE and to transmit the unique identifier of the EVSE to a telematics service provider (TSP), and the TSP, configured to receive the unique identifier of the EVSE from the telematics unit of the PEV and to transmit the unique identifier of the EVSE to the electrical utility.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic diagram of an operating environment for a mobile vehicle communication system usable in implementations of the described principles;

FIG. 2 is a schematic diagram of an operating environment for the charging of an electric vehicle and the transmission of information pertaining to the charging from a telematics unit of the vehicle to an electrical power utility company;

FIG. 3 is a flow chart summarizing an example process for provisioning an electric vehicle supply equipment;

FIG. 4 is a flow chart summarizing an example process executed by a telematics unit for providing information pertaining to the charging of an electric vehicle; and

FIG. 5 is a flow chart summarizing an example process executed by a telematics service provider for providing information pertaining to the charging of an electric vehicle.

### DETAILED DESCRIPTION OF THE DRAWINGS

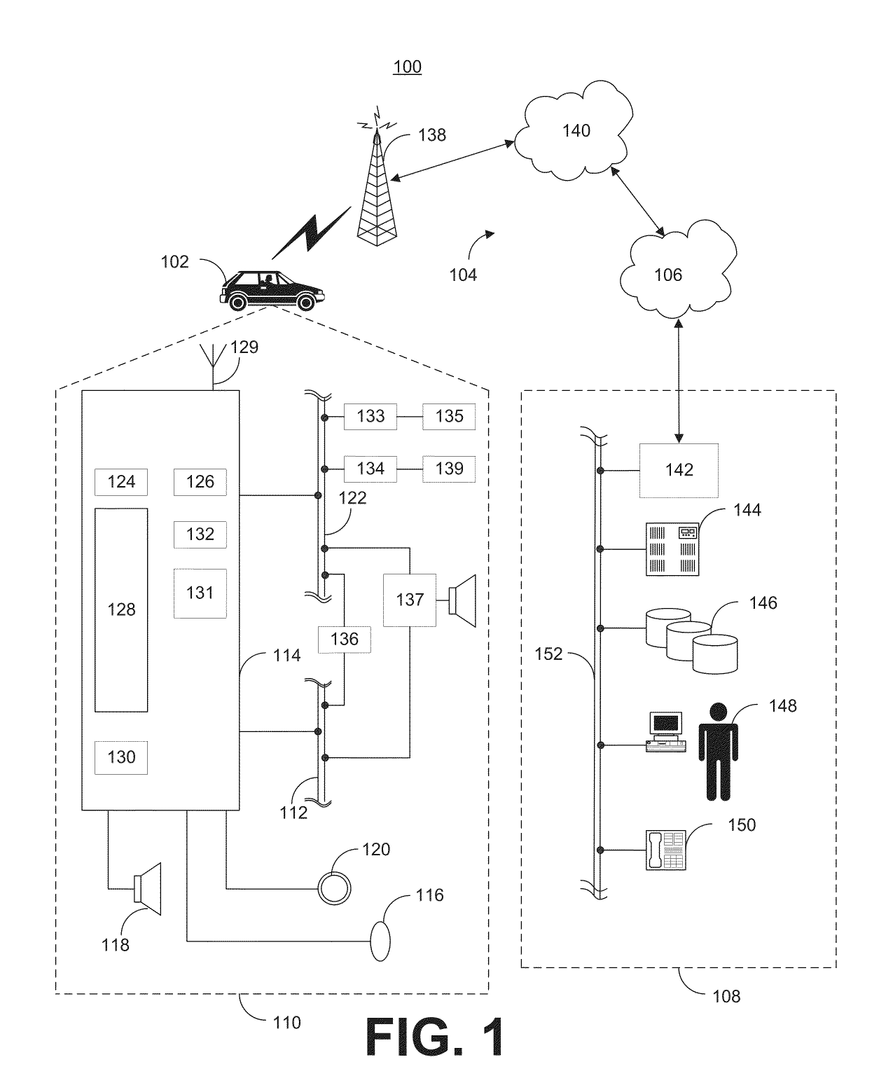

Before discussing the details of the invention, a brief overview of an example telematics system is given to guide the reader. FIG. 1 schematically depicts an example environment for carrying out the invention. It will be appreciated that the described environment is an example, and does not imply any limitation regarding the use of other environments to practice the invention. With reference to FIG. 1 there is shown an example of a communication system 100 that may be used with the present systems and methods and generally includes a vehicle 102, a wireless carrier system 104, a land network 106 and a call center 108. It should be appreciated that the overall architecture, setup and operation, as well as the individual components of a system such as that shown in FIG. 1 are generally known in the art. Thus, the following paragraphs provide a brief overview of one such example information system 100. However, present systems and methods could be carried out in other environments as well.

Vehicle 102 is a mobile vehicle such as a motorcycle, car, truck, recreational vehicle (RV), boat, plane, etc., and is equipped with suitable hardware and software that enables it to communicate over system 100. The vehicle 102 is, in particular, driven by an electric motor that periodically requires recharging. Additionally, vehicle hardware 110 shown generally in FIG. 1 includes: a telematics unit 114, a microphone 116, a speaker 118, and buttons and/or controls 120 connected to the telematics unit 114. A network connection or vehicle bus 122 is operatively coupled to the telematics unit 114. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name but a few.

The telematics unit 114 is an onboard device providing a variety of services through its communication with the call center 108, and generally includes an electronic processing device 128, one or more types of electronic memory 130, a cellular chipset/component 124, a wireless modem 126, a dual antenna 129 and a navigation unit containing a GPS chipset/component 132. The GPS chipset/component is capable of determining the location of the vehicle with a high degree of accuracy. For example, the GPS chipset/component could determine that an electric vehicle is located at a particular electric vehicle charging station. In one example, the wireless modem 126 comprises, and is carried out in the form of, a computer program and/or set of software routines executing within the electronic processing device 128. The cellular chipset/component 124 and the wireless modem 126 may be called the network access device (NAD) of the telematics unit 114. The NAD 114 further includes a short-range wireless unit 131 capable of communicating with a user's mobile device such as a cellular phone, tablet computer, PDA, or the like, over a short-range wireless protocol. For example, in one implementation, the short-range wireless unit 131 is a Bluetooth unit with an RF transceiver that communicates with a user's mobile device using Bluetooth protocol. In some implementations, the short range wireless unit 131 may communicate with an electric vehicle supply equipment (EVSE).

The telematics unit 114 provides a variety of services for subscribers. Examples of such services include: turn-by-turn directions and other navigation-related services provided in conjunction with the GPS based chipset/component 132; airbag deployment notification and other emergency or roadside assistance-related services provided in connection with various crash and or collision sensor interface modules 133 and sensors 135 located throughout the vehicle.

GPS navigation services are implemented based on the geographic position information of the vehicle provided by the GPS based chipset/component 132. A user of the telematics unit enters a destination using inputs corresponding to the GPS component, and a route to a destination is calculated based on the destination address and a current position of the vehicle determined at approximately the time of route calculation. Turn-by-turn (TBT) directions may further be provided on a display screen corresponding to the GPS component and/or through vocal directions provided through a vehicle audio component 137. It will be appreciated that the calculation-related processing may occur at the telematics unit or may occur at a call center 108.

Infotainment-related services are provided by the TSP wherein music, Web pages, movies, television programs, video games and/or other content is downloaded to an infotainment center 136 operatively connected to the telematics unit 114 via a vehicle bus 122 and an audio bus 112. In one example, downloaded content is stored for current or later playback.

The preceding list of functions is by no means an exhaustive list of all of the capabilities of telematics unit 114, as should be appreciated by those skilled in the art, but is simply an illustration of some of the services that the telematics unit 114 offers. The telematics unit 114 may include a number of components known by those skilled in the art in addition to those described above.

Vehicle communications use radio transmissions to establish a communications channel within the wireless carrier system 104 so that voice and/or data transmissions occur over the communications channel. Vehicle communications are enabled via the cellular chipset/component 124 for voice communications and a wireless modem 126 for data transmission. For example, data pertaining to a forecast of a utility's renewable energy mixture can be transmitted to the telematics unit 114 via the wireless modem 126.

To enable successful data transmission over the communications channel, wireless modem 126 applies some form of encoding or modulation to convert the digital data so that it can communicate through a vocoder or speech codec incorporated in the cellular chipset/component 124. Any suitable encoding or modulation technique that provides an acceptable data rate and bit error can be used with the present method. The dual mode antenna 129 services the GPS chipset/component and the cellular chipset/component.

The microphone 116 provides the driver or other vehicle occupant with a means for inputting verbal or other auditory commands, and can be equipped with an embedded voice processing unit utilizing a human/machine interface (HMI) technology known in the art. Conversely, the speaker 118 provides verbal output to the vehicle occupants and can be either a stand-alone speaker specifically dedicated for use with the telematics unit 114 or can be part of the vehicle audio component 137. In either event, the microphone 116 and the speaker 118 enable vehicle hardware 110 and the call center 108 to communicate with the occupants through audible speech.

The vehicle hardware also includes the one or more buttons or controls 120 configured to enable a vehicle occupant to activate or engage one or more of the vehicle hardware components 110. For example, one of the buttons 120 is an electronic push button that, when pressed, initiates voice communication with the call center 108 (whether it be a live advisor 148 or an automated call response system). In another example, one of the buttons 120, when pushed, initiates emergency services.

The audio component 137 is operatively connected to the vehicle bus 122 and the audio bus 112. The audio component 137 receives analog information, rendering it as sound, via the audio bus 112. Digital information is received via the vehicle bus 122. The audio component 137 provides AM and FM radio, CD, DVD, and multimedia functionality independent of the infotainment center 136. The audio component 137 contains a speaker system, or alternatively utilizes the speaker 118 via arbitration on the vehicle bus 122 and/or the audio bus 112.

The vehicle crash and/or collision detection sensor interface 133 is operatively connected to the vehicle bus 122. The crash sensors 135 provide information to the telematics unit 114 via the crash and/or collision detection sensor interface 133 regarding the severity of a vehicle collision, such as the angle of impact and the amount of force sustained.

Vehicle sensors 139, connected to various sensor interface modules 134 are operatively connected to the vehicle bus 122. Vehicle sensors 139 include sensors with capabilities that include but that are not limited to determining a battery's state of charge (e.g. as a percentage of the total charge capacity), the charging status of a battery (i.e. whether the battery is currently being charged), and the current rate at which the battery is being charged (e.g. as a rate of change of the percentage of capacity charged per unit time). The vehicle sensors 139 may further include sensors for detecting and receiving power line communications (PLC) from an EVSE. The vehicle sensors 139 can also include but are not limited to gyroscopes, accelerometers, magnetometers, emission detection and/or control sensors, and the like. The sensor interface modules 134 can include power train control, climate control, and body control, to name but a few.

The wireless carrier system 104 can be a cellular telephone system or any other suitable wireless system that transmits signals between the vehicle hardware 110 and the land network 106. According to an example, the wireless carrier system 104 includes one or more cell towers 138, base stations and/or mobile switching centers (MSCs) 140, as well as any other networking components required to connect the wireless system 104 with the land network 106. The mobile switching center may include a remote data server.

As appreciated by those skilled in the art, various cell tower/base station/MSC arrangements are possible and could be used with the wireless system 104 (also referred to as the “cellular network” herein). For example, a base station and a cell tower could be co-located at the same site or they could be remotely located, a single base station could be coupled to various cell towers, and various base stations could be coupled with a single MSC, to name but a few of the possible arrangements. Preferably, a speech codec or vocoder is incorporated in one or more of the base stations, but depending on the particular architecture of the wireless network, it could be incorporated within a Mobile Switching Center or some other network component as well.

The land network 106 is, for example, a conventional land-based telecommunications network connected to one or more landline telephones and connecting wireless carrier network 104 to call center 108. For example, the land network 106 includes a public switched telephone network (PSTN) and/or an Internet protocol (IP) network, as is appreciated by those skilled in the art. Of course, one or more segments of the land network 106 are implemented in the form of a standard wired network, a fiber or other optical network, a cable network, other wireless networks such as wireless local networks (WLANs) or networks providing broadband wireless access (BWA), or any combination thereof.

The call Center (OCC) 108 is designed to provide the vehicle hardware 110 with a number of different system back-end functions and, according to the example shown here, generally includes one or more switches 142, servers 144, databases 146, live advisors 148, and a variety of other telecommunication and computer equipment 150 that is known to those skilled in the art. These various call center components are coupled to one another, for example, via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of telecommunication and computer equipment 150 for demodulation and further signal processing.

The telecommunication and computer equipment 150 includes a modem that preferably includes an encoder, as previously explained, and can be connected to various devices such as application servers 144 and databases 146. For example, the databases 146 could be designed to store subscriber profile records, subscriber behavioral patterns, or any other pertinent subscriber information. Although the illustrated example has been described as it would be used in conjunction with a manned call center, it will be appreciated that the call center 108 can be any central or remote facility, manned or unmanned, mobile or fixed, to or from which it is desirable to exchange voice and data.

A portion of the databases 146 stores information pertaining to the identity of the telematics unit 114. For example, the databases 146 may store, for each vehicle enrolled in a program, an integrated circuit card identifier (ICCID) corresponding to the subscriber identity modules (SIMs) of the vehicle's telematics unit, an international mobile equipment identity (IMEI) corresponding to network access devices (NADs) integrated into the vehicle's telematics units, a mobile identification number (MIN), an electronic serial numbers (ESN), a mobile equipment identifier (MEID), an international mobile subscriber identity (IMSI) associated with the SIM cards of the vehicle's telematics unit, a mobile device number (MDN), a mobile station international subscriber directory number (MSISDN), a service set identifier (SSID), a media access control (MAC) address, and an internet protocol (IP) address associated with the vehicle's telematics unit. Additional information pertaining to a subscriber affiliated with a particular telematics unit 114 may also be stored in the databases 146. For example, billing information associated with the subscriber may be stored in the databases 146. The preceding examples of information that can be stored at databases 146 is not exhaustive, and additional fields of data may also be stored at databases 146.

The servers 144 interface with utility companies that supply electricity (not shown), databases 146, and telematics units such as the telematics unit 114. The servers 144 have processors that can be configured to request and receive information from telematics units such as the telematics unit 114. In some implementations, information requested and received by the servers 144 is stored in the databases 146. Furthermore, the servers 144 may communicate with the utility companies that supply electricity (not shown) through a land network, such as land network 106, through a wireless carrier system, such as e.g., wireless carrier system 104, or through a combination of a land network and a wireless carrier system.

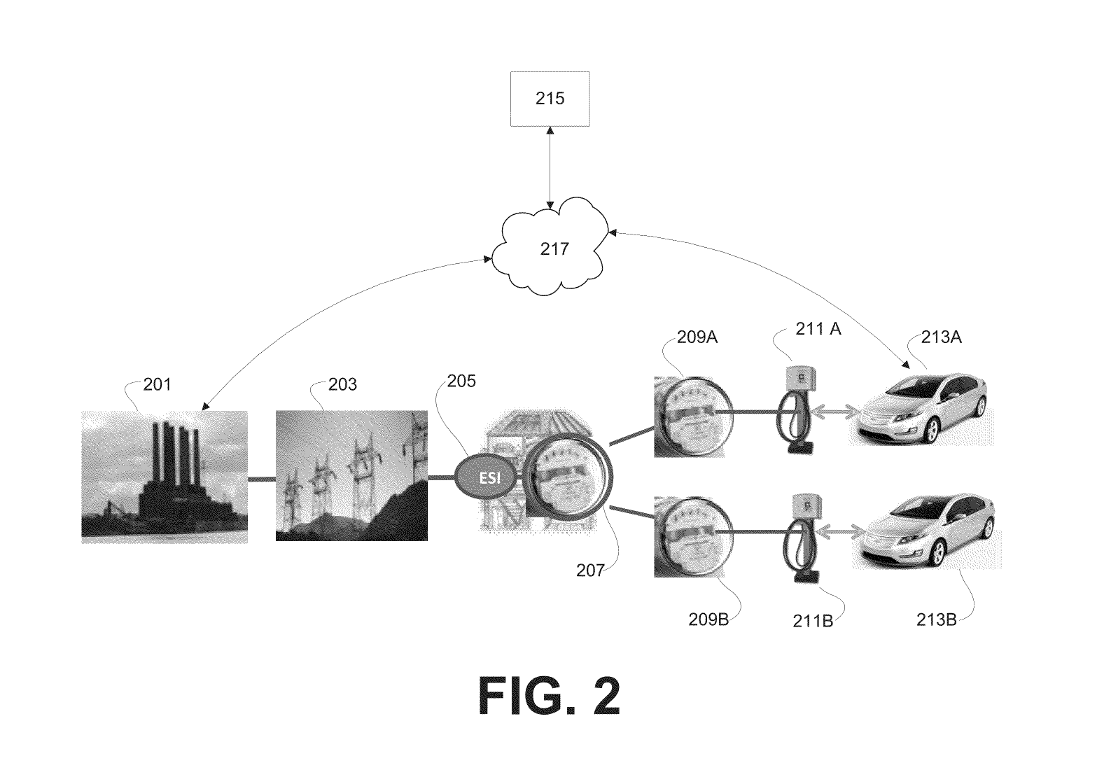

FIG. 2 is a schematic diagram of an operating environment for the charging of an electric vehicle and the transmission of information pertaining to the charging from a telematics unit of the vehicle to an electrical power utility. Electrical power utility operations control center (EPUOCC) 201 is connected to utility communications network 203. EPUOCC 201 may receive, store, analyze, and process a variety of information pertaining to operations of the electrical power utility. Utility communications network 203 transmits information to and from the EPUOCC 201. Energy services interface (ESI) 205 is a portal through which information is transmitted to and from the utility communications network 203. For example, information pertaining to the amount of power that is consumed at one or more home area networks (HAN), such as HAN 207, may be transmitted to the utility communications network 203 and ultimately to the utility operations and control center through the ESI 205. Automated metering infrastructure (AMI) 207 measures the amount of power consumed by one or more nodes on the HAN. For example, AMI 207 may determine that the amount of power consumed at energy user metering devices (EUMD) 209A and 209B. EUMD 209A and 209B in turn measure the amount of power transmitted through electric vehicle supply equipment (EVSE) 211A and 211B. Electric vehicles 213A and 213B receive electrical power from EVSE 211A and 211B, respectively. Electric vehicles 213A and 213B are equipped with telematics units, such as telematics unit 114 of FIG. 1, which enable communication with EPUOCC 201. For example, the telematics units of electric vehicles 213A and 213B can transmit information pertaining to unique identifiers of EVSEs 211A and 211B to the EPUOCC 201. In some implementations the telematics units of electric vehicles 213A and 213B transmit information directly to the EPUOCC 201 through network 217 while in other implementations the telematics units transmit information to telematics service provider (TSP) 215 through network 217 and the TSP subsequently transmits information to the EPUOCC 201 through network 217. Network 217 may be a wireless network, a wired network, or may include a combination of wireless and wired networks.

In general terms, not intended to limit the claims, the example environment depicted by FIGS. 1 and 2 may be used by systems and methods that transmit information, which is acquired or ascertained by an electric vehicle and which pertains to a charging event of the electric vehicle, from the vehicle to the electrical power utility that provides the electricity used to charge the vehicle. In some implementations, the information acquired or ascertained by the vehicle is first transmitted to a telematics service provider (TSP) and is thereafter transmitted by the TSP to the utility in company. In such implementations, the TSP may also transmit additional information to the electrical power utility. Such additional information may be associated with the telematics unit, with the vehicle, or with a subscriber account associated with the telematics unit or vehicle.

Embodiments of the systems and methods contemplated by the present invention enable an electrical power utility to bill, either directly or through a TSP, owners of electric vehicles that utilize electric vehicle supply equipment (EVSE) operated by the electrical power utility. Some embodiments of the systems and methods contemplated herein enable utility companies to control access to EVSE. For example, access could be limited to a particular group of vehicles that constitute a whitelist. Alternatively, access could be restricted from a particular group of vehicles that constitute a blacklist. Embodiments of the systems and methods contemplated by the present disclosure utilize the communicative abilities of telematics equipped vehicles to communicate information pertaining to the provision of services to an electrical power utility and thereby obviate the need for EVSE to have and utilize its own communications infrastructure capable of exchanging information with an electrical power utility or TSP.

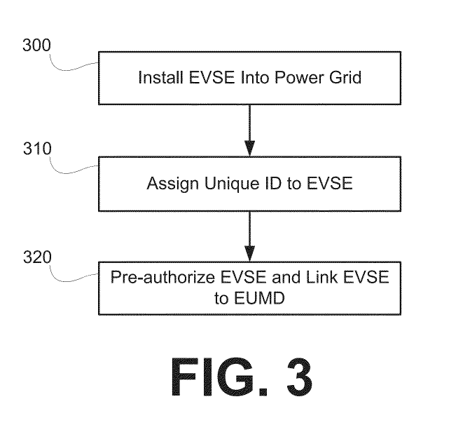

FIG. 3 is a flow chart summarizing an example process for provisioning an electric vehicle supply equipment (EVSE) 211. At step 300, the EVSE 211 is installed. At step 310, the EVSE 211 is assigned a unique identifier. In some implementations, the EVSE 211 will be compliant with ISO/IEC 15118 or SAE J2931 standards and will be equipped with power line communication (PLC) technology that enables data to be carried to an electric vehicle on a conducting connection that simultaneously transmits electrical power to the vehicle. For example, a unique identifier may be assigned to every EVSE within the data transmission network. In some implementations, the unique identifier is a media access control (MAC) address that is assigned by the manufacturer of the EVSE. In other implementations, the unique identifier is a MAC address assigned to the EVSE by a network administrator. At step 320, the EVSE 211 completes a pre-authorization procedure thereby becoming registered with the electrical power utility that provides electrical power to the EVSE 211. During the pre-authorization procedure, the EVSE 211 is linked to an energy user metering device (EUMD) 209 that monitors the amount of electrical power supplied to vehicles by the EVSE 211. In this manner, a single, unique EVSE can be identified by the electrical power utility as being linked to a single, unique EUMD. For example, EVSE 211A can be linked to EUMD 209A and EVSE 211B can be linked to EUMD 209B.

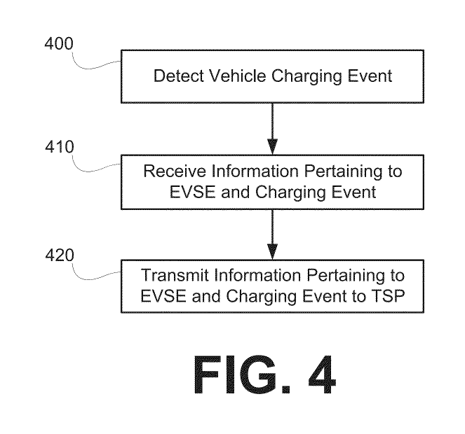

FIG. 4 is a flow chart summarizing an example process executed by telematics unit 114 for providing information pertaining to the charging of an electric vehicle. At step 400, the telematics unit 114 detects a vehicle charging event. The telematics unit 114 may detect a charging event through vehicle sensors 139 and information pertaining to the charging event may be communicated to the telematics unit 114 through sensor interface modules 134 and the vehicle bus 122. In alternative implementations, the telematics unit 114 may detect a vehicle charging event through a connection established between electric vehicle supply equipment (EVSE) 211 and the short range wireless unit 131 of the telematics unit 114. For example, the EVSE 211 may be equipped with Bluetooth or other WPAN technologies and may attempt to connect with the vehicle that is charging through such technologies upon the initiation of a charging event. In other alternative implementations, near field communication (NFC) technologies may be used to transmit information from the EVSE 211 to the vehicle.

At step 410, the telematics unit 114 receives information pertaining to the identity of the EVSE 211 from which the vehicle is receiving electrical power during the charging event. In some implementations, the information is a media access control (MAC) address assigned to the EVSE 211. The MAC address may be assigned to the EVSE 211 by the manufacturer of the EVSE 211, or the MAC address may be assigned to the EVSE 211 by a network administrator. For example, upon the integration of the EVSE 211 into the supply grid of the electrical power utility, the administrator of the utility communications network 203, e.g. the electrical power utility or an entity affiliated with the electrical power utility, may assign a unique MAC address to the EVSE 211. In some implementations, the information pertaining to the identity of the EVSE 211 may be pushed to the electric vehicle by the EVSE 211 during charging. In other implementations, the electric vehicle may request information pertaining to the identity of the EVSE 211 from the EVSE 211 upon detecting a vehicle charging event. For example, the telematics unit 114 may detect a vehicle charging event through a PLC connection, through an NFC connection, or through a WPAN connection, and receive information through the same connection or through one of the other types of connection. In implementations where the telematics unit 114 requests information pertaining to the identity of the EVSE 211, the telematics unit 114 may transmit the request through a PLC connection, through an NFC connection, or through a WPAN connection, irrespective of whether the vehicle charging event is detected through the same type of connection and also irrespective of whether the information is transmitted to the telematics unit 114 by the EVSE 211 through the same type of connection.

In some implementations, the telematics unit 114 may also receive instructions from the EVSE 211. The instructions received by the telematics unit 114 may be received from the EVSE 211 through a PLC connection, through an NFC connection, or through a WPAN connection. In some implementations, the telematics unit 114 requests that the EVSE 211 transmit instructions to the telematics unit. In implementations where the telematics unit 114 requests instructions from the EVSE 211, the telematics unit 114 may transmit the request through a PLC connection, through an NFC connection, or through a WPAN connection, irrespective of whether the EVSE 211 transmits the instructions through the same type of connection. The instructions received by the telematics unit 114 at step 410 may direct the telematics unit to transmit information to a TSP or to transmit information directly to the utility operations and control center 201 of the electrical utility. Similarly, the instructions received by the telematics unit 114 at step 410 may direct the telematics unit not to transmit certain information or types of information to a TSP or to the electrical power utility operations and control center (EPUOCC) 201 of the electrical utility. In some implementations, the instructions received at step 410 by the telematics unit 114 may include instructions that direct the TSP to transmit certain information or types of information to the EPUOCC 201. Similarly, the instructions received at step 410 by the telematics unit 114 may include instructions that direct the TSP not to transmit certain information or types of information to the EPUOCC 201.

At step 420, the telematics unit 114 transmits the information received from the EVSE 211 at step 410 to a telematics service provider (TSP). In some implementations, the telematics unit 114 also transmits additional information pertaining to the telematics unit 114 itself or the vehicle 102 to the TSP. The additional information transmitted by the telematics unit 114 may include an integrated circuit card identifier (ICCID) corresponding to the subscriber identity module (SIM) of the telematics unit 114, an international mobile equipment identity (IMEI) corresponding to network access device (NAD) integrated into the telematics unit 114, a mobile identification number (MIN), an electronic serial number (ESN), a mobile equipment identifier (MEID), an international mobile subscriber identity (IMSI) associated with the SIM card of the telematics unit 114, a mobile device number (MDN), a mobile station international subscriber directory number (MSISDN), a service set identifier (SSID), a media access control (MAC) address associated with the telematics unit 114, and an internet protocol (IP) address associated with the telematics unit 114. The additional information transmitted by the telematics unit 114 may also include information pertaining to the charging event. Such additional information pertaining to the charging event may include the time at which the charging event took place, the total amount of electrical power obtained by the vehicle from the EVSE 211 during the charging event (e.g. in kWh), the price of the electrical power obtained by the vehicle during the charging event (e.g. in dollars/kWh), the total price of the electrical power obtained by the vehicle during the charging event (e.g. in dollars), and the geographic location at which the charging event took place (e.g. as GPS coordinates).

Additionally at step 420, the telematics unit 114 may transmit instructions to the TSP. The instructions transmitted at step 420 may direct the TSP to forward the information transmitted by the telematics unit 114 on to the EPUOCC 201 of the electrical utility providing power to the EVSE 211. In addition, the instructions transmitted by the telematics unit 114 to the TSP may direct the TSP to transmit information pertaining to the telematics unit 114 or a subscriber account associated with the telematics unit 114 to the EPUOCC 201. For example, the instructions may direct the TSP to transmit to the EPUOCC 201 the identity of a subscriber account associated with the telematics unit 114, the affiliation of a subscriber account associated with the telematics unit 114 with a payment plan or promotion offered by the utility or a third party, information pertaining to a subscriber's membership in an organization, a credit rating associated with a subscriber account, an account balance of a subscriber account, and information pertaining to payment history of a subscriber account. The instructions transmitted by the telematics unit 114 to the TSP may further direct the TSP to authorize a payment for the electrical power received by the vehicle 102 during the charging event or to debit the account of the subscriber associated with the telematics unit 114 in the amount of the cost of the electrical power received during the charging event.

In alternative implementations, the telematics unit 114 transmits information to both the TSP and to the EPUOCC 201. In such implementations, information that is transmitted to the TSP may also be transmitted to the EPUOCC 201. In further alternative implementations, the telematics unit 114 transmits information only to the EPUOCC 201. The types of information that may be transmitted to the EPUOCC 201 and to the TSP may include but are not limited to information pertaining to the telematics unit 114, the charging event, the EVSE 211, a subscriber account associated with the telematics unit 114, and various instructions, including all of the types of information specifically enumerated supra.

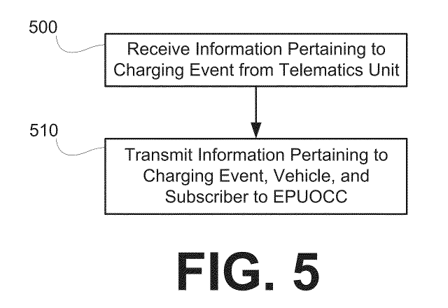

FIG. 5 is a flow chart summarizing an example process executed by a telematics service provider (TSP) for providing information pertaining to the charging of an electric vehicle. At step 500, the TSP receives information pertaining to a charging event from telematics unit 114. In some implementations, the TSP receives the information at step 500 as a result of the information being pushed to the TSP by the telematics unit 114. In other implementations, the TSP receives the information at step 500 as a result of first requesting the information from the telematics unit 114. In some of the implementations where the TSP requests the information from the telematics unit 114, the request is triggered by the receipt of information by the TSP indicating that the vehicle associated with the telematics unit 114 is undergoing a charging event.

The information received by the TSP at step 500 may include information pertaining to the identity of electric vehicle supply equipment (EVSE) 211. In some implementations, the information is a media access control (MAC) address assigned to the EVSE 211. The MAC address may be assigned to the EVSE 211 by the manufacturer of the EVSE 211, or the MAC address may be assigned to the EVSE 211 by a network administrator. For example, upon the integration of the EVSE 211 into the supply grid of the electrical power utility, the administrator of the utility communications network 203, e.g. the electrical power utility or an entity affiliated with the electrical power utility, may assign a unique MAC address to the EVSE 211.

The information received by the TSP at step 500 may also include information pertaining to the identity of the telematics unit 114. The information pertaining to the telematics unit 114 may include an integrated circuit card identifier (ICCID) corresponding to the subscriber identity module (SIM) of the telematics unit 114, an international mobile equipment identity (IMEI) corresponding to network access device (NAD) integrated into the telematics unit 114, a mobile identification number (MIN), an electronic serial number (ESN), a mobile equipment identifier (MEID), an international mobile subscriber identity (IMSI) associated with the SIM card of the telematics unit 114, a mobile device number (MDN), a mobile station international subscriber directory number (MSISDN), a service set identifier (SSID), a media access control (MAC) address associated with the telematics unit 114, and an internet protocol (IP) address associated with the telematics unit 114. The information received by the TSP at step 500 may also include information pertaining to the charging event. Information received by the TSP at step 500 pertaining to the charging event may include the time at which the charging event took place, the total amount of electrical power obtained by the vehicle from the EVSE 211 during the charging event (e.g. in kWh), the price of the electrical power obtained by the vehicle during the charging event (e.g. in dollars/kWh), the total price of the electrical power obtained by the vehicle during the charging event (e.g. in dollars), and the geographic location at which the charging event took place (e.g. as GPS coordinates).

The information received by the TSP at step 500 may further include instructions for the TSP. The instructions for the TSP may direct the TSP to forward the information received from the telematics unit 114 to the utility operations and control center (EPUOCC) 201 of the electrical power utility providing power to the EVSE 211. In addition, the instructions received by the TSP at step 500 may direct the TSP to transmit information pertaining to the telematics unit 114 or a subscriber account associated with the telematics unit 114 to the EPUOCC 201. For example, the instructions received by the TSP at step 500 may direct the TSP to transmit to the EPUOCC 201 the identity of a subscriber account associated with the telematics unit 114, the affiliation of a subscriber account associated with the telematics unit 114 with a payment plan or promotion offered by the electrical power utility or a third party, information pertaining to a subscriber's membership in an organization, a credit rating linked to a subscriber account, an account balance of a subscriber account, and information pertaining to payment history of a subscriber account. The instructions received by the TSP at step 500 may further direct the TSP to authorize a payment for the electrical power received by the vehicle 102 during the charging event or to debit the account of the subscriber associated with the telematics unit 114 in an amount equal to the total cost of the electrical power received during the charging.

At step 510, the TSP transmits information to the EPUOCC 201. Information transmitted to the EPUOCC 201 may include information received by the TSP at step 500. For example, the information transmitted to the EPUOCC 201 may include information pertaining to the identity of EVSE 211. In some implementations, the information is a media access control (MAC) address assigned to the EVSE 211. The MAC address may be assigned to the EVSE 211 by the manufacturer of the EVSE 211, or the MAC address may be assigned to the EVSE 211 by a network administrator. For example, upon the integration of the EVSE 211 into the electrical power supply grid of the electrical power utility, the administrator of the utility communications network 203, e.g. the electrical power utility or an entity affiliated with the electrical power utility, may assign a unique MAC address to the EVSE 211. Information transmitted to the EPUOCC 201 at step 510 may include information pertaining to the identity of the telematics unit 114 or a subscriber account associated with the telematics unit 114. For example, information transmitted to the EPUOCC 201 at step 510 may also include information pertaining to the telematics unit 114 may include an integrated circuit card identifier (ICCID) corresponding to the subscriber identity module (SIM) of the telematics unit 114, an international mobile equipment identity (IMEI) corresponding to network access device (NAD) integrated into the telematics unit 114, a mobile identification number (MIN), an electronic serial number (ESN), a mobile equipment identifier (MEID), an international mobile subscriber identity (IMSI) associated with the SIM card of the telematics unit 114, a mobile device number (MDN), a mobile station international subscriber directory number (MSISDN), a service set identifier (SSID), a media access control (MAC) address associated with the telematics unit 114, and an internet protocol (IP) address associated with the telematics unit 114. The information transmitted at step 510 may further include information pertaining to the charging event. Information transmitted at step 510 pertaining to the charging event may include the time at which the charging event took place, the total amount of electrical power obtained by the vehicle from the EVSE 211 during the charging event (e.g. in kWh), the price of the electrical power obtained by the vehicle during the charging event (e.g. in dollars/kWh), the total price of the electrical power obtained by the vehicle during the charging event (e.g. in dollars), and the geographic location at which the charging event took place (e.g. as GPS coordinates).

It will be appreciated by those of skill in the art that the information exchanged between the user, the call center, and the recharging station may vary in content. For example, the call center may have the authority to schedule a recharging event on behalf of the user without allowing the user to select amongst appropriate recharging stations. In such an embodiment, the call center may select the recharging station that is the best match based upon the criteria selected by the user.

It will be appreciated by those of skill in the art that the execution of the various machine-implemented processes and steps described herein may occur via the computerized execution of computer-executable recommendations stored on a tangible computer-readable medium, e.g., RAM, ROM, PROM, volatile, nonvolatile, or other electronic memory mechanism. Thus, for example, the operations performed by the telematics unit may be carried out according to stored recommendations or applications installed on the telematics unit, and operation performed at the call center may be carried out according to stored recommendations or applications installed at the call center.

It is thus contemplated that other implementations of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for transmitting information pertaining to a charging event of a plug-in electric vehicle (PEV) to an electrical utility, wherein the electrical utility is the provider of the electrical power acquired by the PEV during the charging event, the method comprising:
receiving, at a telematics unit of the PEV, information pertaining to the charging event;
transmitting, by the telematics unit, the information pertaining to the charging event or a subset thereof to a telematics service provider (TSP); and
transmitting, by the telematics unit, instructions directing the TSP to transmit the information pertaining to the charging event or a subset thereof to the electrical utility,
wherein the information pertaining to the charging event comprises a unique identifier of an electric vehicle supply equipment (EVSE).

2. The method of claim 1, wherein the unique identifier of the EVSE is a media access control (MAC) address assigned to the EVSE.

3. The method of claim 2, wherein the MAC address assigned to the EVSE is assigned by an administrator of a communications network of the electrical utility.

4. The method of claim 1, further comprising:
transmitting, by the telematics unit, information in addition to the information pertaining to the charging event received by the telematics unit;
wherein the information in addition to the information pertaining to the charging event received by the telematics unit comprises information pertaining to the identity of the telematics unit.

5. The method of claim 4, wherein the information pertaining to the identity of the telematics unit includes one of the group consisting of: an integrated circuit card identifier (ICCID) corresponding to a subscriber identity module (SIM) of the telematics unit, an international mobile equipment identity (IMEI) corresponding to a network access device (NAD) integrated into the telematics unit, a mobile identification number (MIN), an electronic serial number (ESN), a mobile equipment identifier (MEID), an international mobile subscriber identity (IMSI) associated with the SIM card of the telematics unit, a mobile device number (MDN), a mobile station international subscriber directory number (MSISDN), a service set identifier (SSID), a media access control (MAC) address associated with the telematics unit, and an internet protocol (IP) address associated with the telematics unit.

6. The method of claim 1, further comprising:
transmitting, by the telematics unit, information in addition to the information pertaining to the charging event received by the telematics unit;
wherein the information in addition to the information pertaining to the charging event received by the telematics unit comprises information pertaining to the charging event.

7. The method of claim 6, wherein the information pertaining to the charging event includes one of the group consisting of: the time at which the charging event took place, the total amount of electrical power obtained by the vehicle from the EVSE during the charging event, the price per unit of electrical power of the electrical power obtained by the vehicle during the charging event, the total price of the electrical power obtained by the vehicle during the charging event, and the geographic location at which the charging event took place.

8. The method of claim 1, further comprising:
transmitting, by the telematics unit, additional instructions directing the TSP to perform one of the group consisting of: transmitting the identity of a subscriber account associated with the telematics unit to the electrical utility, transmitting to the electrical utility the affiliation of a subscriber account associated with the telematics unit with a promotion offered by the utility or a third party, transmitting information pertaining to a subscriber's membership in an organization to the electrical utility, transmitting an account balance of a subscriber account associated with the telematics unit to the electrical utility, authorizing a payment for the electrical power received by the vehicle during the charging event, and authorizing the debit of an account of a subscriber associated with the telematics unit.

9. A method for transmitting information pertaining to a charging event of a plug-in electric vehicle (PEV) to an electrical utility, wherein the electrical utility is the provider of the electrical power acquired by the PEV during the charging event, the method comprising:
receiving, at a telematics service provider (TSP), information pertaining to the charging event; and
transmitting, by the TSP, the information pertaining to the charging event or a subset thereof to the electrical utility;
wherein the information pertaining to the charging event comprises a unique identifier of an electric vehicle supply equipment (EVSE).

10. The method of claim 9, wherein the unique identifier of the EVSE is a media access control (MAC) address assigned to the EVSE.

11. The method of claim 10, wherein the MAC address assigned to the EVSE is assigned by an administrator of a communications network of the electrical utility.

12. The method of claim 9, wherein the information pertaining to the charging event further comprises information pertaining to the identity of the telematics unit.

13. The method of claim 13, wherein the information pertaining to the identity of the telematics unit includes one of the group consisting of: an integrated circuit card identifier (ICCID) corresponding to a subscriber identity module (SIM) of the telematics unit, an international mobile equipment identity (IMEI) corresponding to a network access device (NAD) integrated into the telematics unit, a mobile identification number (MIN), an electronic serial number (ESN), a mobile equipment identifier (MEID), an international mobile subscriber identity (IMSI) associated with the SIM card of the telematics unit, a mobile device number (MDN), a mobile station international subscriber directory number (MSISDN), a service set identifier (SSID), a media access control (MAC) address associated with the telematics unit, and an internet protocol (IP) address associated with the telematics unit.

14. The method of claim 9, wherein the information pertaining to the charging event further comprises one of the group consisting of: the time at which the charging event took place, the total amount of electrical power obtained by the vehicle from the EVSE during the charging event, the price per unit of electrical power of the electrical power obtained by the vehicle during the charging event, the total price of the electrical power obtained by the vehicle during the charging event, and the geographic location at which the charging event took place.

15. The method of claim 9, further comprising:
receiving, by the TSP, instructions from the telematics unit directing the TSP to perform one of the group consisting of: transmitting the identity of a subscriber account associated with the telematics unit to the electrical utility, transmitting to the electrical utility the affiliation of a subscriber account associated with the telematics unit with a promotion offered by the utility or a third party, transmitting information pertaining to a subscriber's membership in an organization to the electrical utility, transmitting an account balance of a subscriber account associated with the telematics unit to the electrical utility, authorizing a payment for the electrical power received by the vehicle during the charging event, and authorizing the debit of an account of a subscriber associated with the telematics unit.

16. The method of claim 15, wherein the instruction from the telematics unit were transmitted to the telematics unit by the EVSE.

17. A system for transmitting information pertaining to a charging event of a plug-in electric vehicle (PEV) to an electrical utility, wherein the electrical utility is the provider of the electrical power acquired by the PEV during the charging event, the system comprising:
an electric vehicle supply equipment (EVSE) configured to supply electrical power to the PEV and to transmit its unique identifier to a telematics unit of the PEV;
the telematics unit of the PEV configured to receive the unique identifier of the EVSE and to transmit the unique identifier of the EVSE to a telematics service provider (TSP); and
the TSP, configured to receive the unique identifier of the EVSE from the telematics unit of the PEV and to transmit the unique identifier of the EVSE to the electrical utility.

18. The system of claim 17, wherein the unique identifier of the EVSE is a media access control (MAC) address assigned to the EVSE.

19. The system of claim 18, wherein the MAC address assigned to the EVSE is assigned by an administrator of a communications network of the electrical utility.

20. The system of claim 17, wherein the telematics unit is further configured to provide additional information pertaining to the charging event to the TSP;
wherein the additional information pertaining to the charging event comprises one of the group consisting of: the time at which the charging event took place, the total amount of electrical power obtained by the vehicle from the EVSE during the charging event, the price per unit of electrical power of the electrical power obtained by the vehicle during the charging event, the total price of the electrical power obtained by the vehicle during the charging event, and the geographic location at which the charging event took place.
